(19) United States
(12) Patent Application Publication
(10) Pub. No.: US 2006/0000249 A1
(43) Pub. Date: Jan. 5, 2006

(54) Disc lock reminder

(76) Inventors: Thomas Evan DeMaio, Pasadena, CA (US); Ruben Adonay Jimenez, Los Angeles, CA (US)

Correspondence Address: JOSEPH E. MUETH, ESQ., 8TH FLOOR, 225 SOUTH LAKE AVE., PASADENA, CA, 91101, US

(21) Appl. No.: 10/885,524

(22) Filed: Jun. 30, 2004

(51) Int. Cl. E05B 67/36; E05B 17/00

(52) U.S. Cl. 70/441

(57) ABSTRACT

A motorcycle disc lock reminder comprising a key having a head portion carrying a loop, and a key blank portion, said key blank portion being adapted to be received and held in the ignition switch of a motorcycle and being incapable of operating said ignition switch. The disc lock reminder serves to provide a reminder or warning that a disc lock is locked into place on one of the wheels of a motorcycle.

### BACKGROUND OF INVENTION

The risk of theft of motorcycles is reduced by the use of a wheel disc lock which is inserted into the either the front or rear wheel when parking.

Many members of the motorcycle population who use a disc lock as an anti-theft device have at one time or another forgotten the device was attached and have tried to ride off, causing a very embarrassing and costly low speed crash.

A warning sticker usually comes with the lock and is attached below the ignition as a reminder. However, forgetfully, on numerous occasions, motorcyclists have proceeded to ride off and crash. It is common among disc lock users to have motorcycles come into repair shops with damage from a disc lock crash.

U.S. Pat. No. 6,178,787 issued to Titterton disclosed a motorcycle wheel disc lock reminder system for reminding a user that a disk lock is mounted to the wheel of the user's motorcycle so that the user does not drive the motorcycle with the disk lock attached to the wheel. The motorcycle wheel disk lock reminder system includes a disk lock adapted for attachment to a wheel of a motorcycle. The disk lock has a slot therein into which an insertion tab outwardly extending from an inner face of a reminder unit is removably inserted. The insertion tab of the reminder unit is also insertable into an ignition keyhole of the motorcycle subsequent removable of the insertion tab from the slot of the disk lock to prevent insertion of an ignition key into the ignition keyhole without prior removal therefrom of the insertion tab of the reminder unit. The Titterton lock is required to be especially made to provide a slot for receiving the tab.

U.S. Pat. No. 6,236,307 issued to Kurano disclosed a vehicle lock and alarm which includes a lock motion detection sensor and a transmitter to transmit signals from the detection sensor.

### SUMMARY OF INVENTION

Briefly, the present invention comprehends a motorcycle disc lock reminder comprising a key having a head portion and a key blank portion, said key blank portion being adapted to be received and held in the ignition switch of a motorcycle and being incapable of operating said ignition switch, said disc lock reminder serving to provide a reminder that a disc lock with locking pin is locked into place on one of the wheels of a motorcycle, said head portion being adapted to carry a loop for receiving said locking pin.

According to this invention a key blank with signaling light is used by insertion into the motorcycle ignition switch to warn the motorcyclist that the disc or wheel lock is in place. When the motorcyclist attempts to leave and to insert the ignition key, the flashing light serves as a reminder. With the disc lock reminder in the ignition, it is impossible to start the motorcycle and attempt to ride off while the disc lock is still attached.

In crash prevention, the disc lock reminder of this invention is used with a motorcycle disc lock which attaches to either the front or rear brake disc and prevents the full rotation of the motorcycle wheel to prevent theft.

### DESCRIPTION OF PREFERRED EMBODIMENTS

The disc lock reminder of this invention in one preferred embodiment is fashioned from a flat metal key blank which has been reduced in length and width for easy insertion into any motorcycle ignition. A flat washer can be welded to the top of the key blank and a flashing battery powered light affixed from the rear through a hole in the washer with the on-off switch located on the back of the washer. Identifying words can be written on the front of the washer, such as the words “disc lock”. The washer has a small off center hole drilled therein to accommodate a small circular key ring so that the disc lock reminder can be conveniently attached to the stored disc lock. In another embodiment of the invention, the disc lock reminder is made from a barrel cylinder key blank to accommodate Harley Davidson ignition switches which are barrel cylinder types as opposed to Japanese motorcycles which use standard flat keys.

The practice of this invention does not require any modification of the standard disc lock.

### THE DRAWINGS

Turning to the drawings:

FIG. 1 shows a conventional motorcycle disc lock with the disc lock reminder attached as it is intended to be carried when the disc lock is stored or not locked in place on the front or rear wheel of a motorcycle.

FIG. 2A is a perspective view generally from the top of one preferred embodiment of the disc lock reminder.

FIG. 2B is a perspective view, generally from the top, of another preferred embodiment of the disc lock reminder of this invention.

FIG. 3 is a perspective view from the bottom of the disc lock reminder of FIG. 2A.

FIG. 4 shows the disc lock reminder of FIGS. 1, 2B and 3 in place on the ignition of a Harley Davidson motorcycle to remind the owner that the disc lock shown in FIG. 1 is locked into place on the front or rear wheel.

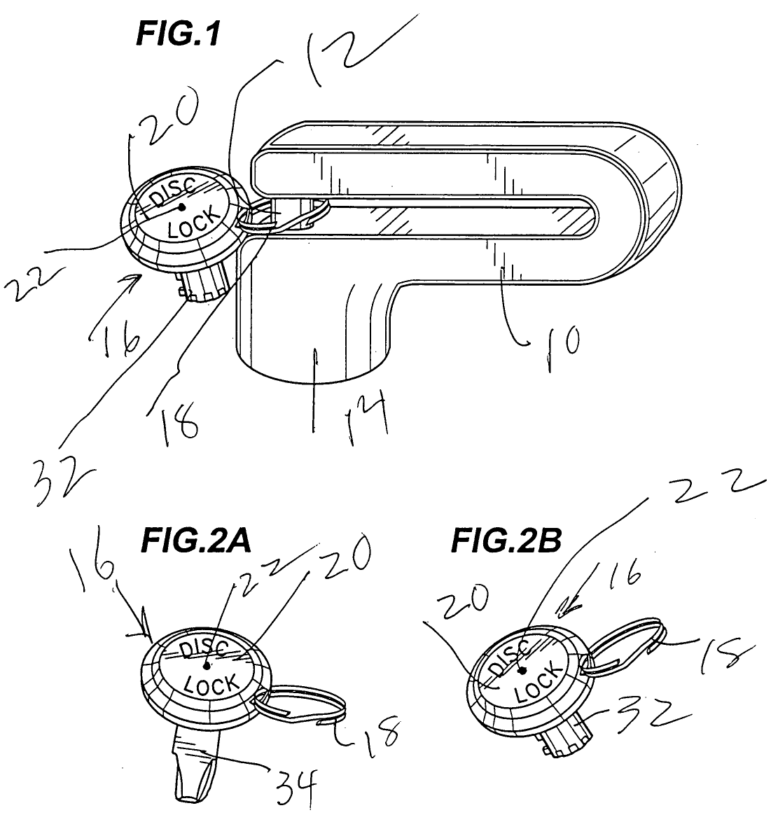

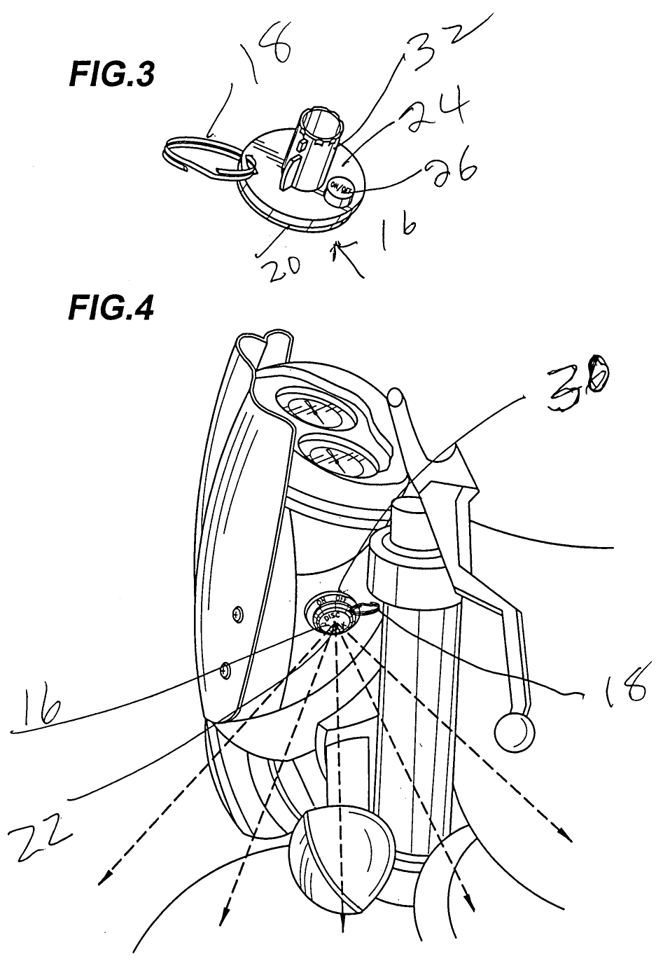

Considering the drawings in more detail, FIGS. 1, 2B, 3 and 4 show the embodiment of the disc lock reminder fitted with a barrel shaped key blank for use in the ignition switch of a Harley-Davidson motorcycle. FIG. 2A is the other equally important and alternative embodiment which uses a flat key blank of the kind which is received in the in the ignition switch of most other motorcycle brands, particularly, the Japanese brands.

The shape of the key blank portion is not important. In general, the key blank portion is typically shorter, and in the case of a flat key blank, is also usually narrower, than the actual ignition key so that the key lock reminder is incapable of being used to turn-on the ignition switch.

The disk lock 10 has a locking pin 12 which is slidably received in the housing 14 for locking engagement and is operated by a standard barrel locking key inserted into the bottom (not shown) of housing 14 when the disc lock is inserted into the front or rear wheel and locked into place. In FIG. 1, the disc lock is shown when it is not in place on a wheel and is in its storage-ready state. The disc lock reminder of this invention, generally 16, can best be held to pin 12 by a key ring 18. The entire assembly of FIG. 1 can be carried in a saddle bag or other storage space or container on the motorcycle.

It is to be understood that key ring 18 is but an example of a loop for receiving the locking pin of a motorcycle disc lock. The loop can be of string, chain, etc. so long as the loop is closed or able to be closed.

When parking a motorcycle, the disc lock 10 is unlocked, the disc lock reminder 16 with key ring 18 is removed from pin 12, and the disc lock is locked into place on one of the motorcycle wheels. The disc lock reminder 16 is then manually inserted into the ignition as shown in FIG. 4.

Optionally, the head 20 of the disc lock reminder is provided with a signaling or warning light or LED which shines through hole 22 in the head to signal to the owner/rider that the disc lock is in place. The head 20 may also include in an interior compartment a power source for the light or LED such as a battery.

The underside 24 of head 20 optionally has a manual switch 26 for turning the light or LED on-and-off.

As indicated, the shape of the key blank portion 28 of the disc lock reminder is shorter than the length of the actual key adapted for operating the ignition switch 30. Nevertheless, the key blank portion must be long enough to be held in place by the ignition switch. The barrel shape of the key blank portion 32 of FIGS. 1, 2B and 3 is receivable in the Harley Davidson ignition switch. The flat key blank portion 34 of FIG. 2A is receivable in virtually all other brands of motorcycles including the popular Japanese models.

The light or LED providing light through hole or opening 22 may be continuously light emitting or flashing and also services to warn would-be thieves that the motorcycle has a disc lock in place. In any case, it reminds the owner of this fact, so that with the que thus provided, the owner will remove the disc lock reminder and also the disc lock itself, thereby preventing the possibility of a spill taking place due to an attempt to mount and ride the motorcycle with the disc lock in place on one of the wheels.

In summary, the idea is that the owner keeps the disc lock reminder attached to the disc lock with the key ring attachment. When the disc lock is attached to a wheel, the disc lock reminder is removed from the disc lock, and the button on the rear is pushed, starting the red light on the front flashing. The owner then inserts the disc lock reminder into the ignition where it blinks on-and-off acting as both the reminder of the disc lock attachment to a wheel, and the illusion of an activated alarm.

When the owner remounts the motorcycle to leave and attempts to insert the ignition key, the flashing light provides a reminder that the disc lock reminder is in the ignition, making it impossible to start the motorcycle and ride off with the disc lock still attached, hence saving the owner's pride by not allowing a crash in public due to forgetfulness or, worse yet, to sustain a serious accident to both person and motorcycle.

1-9. (canceled)

10. The combination of
(a) A motorcycle disc lock reminder comprising a key having a head portion and a key blank portion, said key blank portion being adapted to be received and held in the ignition switch of a motorcycle and being incapable of operating said ignition switch, said disc lock reminder being adapted to serve to provide a reminder that a disc lock with locking pin is locked into place on one of the wheels of a motorcycle; and
(b) a motorcycle disc lock with locking pin; said locking pin being locked into place;
said motorcycle disc lock reminder and said motorcycle disc lock being held together by a key ring which passes through said head portion and over said locking pin.

11. The combination of claim 10 wherein said key blank portion is barrel-shaped.

12. The combination of claim 10 wherein said key blank portion is flat.

13. A motorcycle disc lock reminder comprising a key having a head portion and a key blank portion, said key blank portion being adapted to be received and held in the ignition switch of a motorcycle and being incapable of operating said ignition switch, said disc lock reminder serving to provide a reminder that a motorcycle disc lock with locking pin is locked into place on one of the wheels of a motorcycle, wherein said head portion includes a warning light or LED, and wherein said head portion further includes an off-center key ring passing through said head portion for attachment to a disc lock when the disc lock reminder and disc lock are in a storage-ready state and wherein said key ring is in the form of a loop large enough to receive said locking pin.

14. The combination of a motorcycle ignition switch having received therein the disc lock reminder of claim 13, wherein said key blank portion is held in said ignition switch.
